(19) United States
(12) Patent Application Publication
(10) Pub. No.: US 2009/0022230 A1
(43) Pub. Date: Jan. 22, 2009

(54) METHOD OF SPATIAL AND SNR FINE GRANULAR SCALABLE VIDEO ENCODING AND TRANSMISSION

(75) Inventor: Ihor Kirenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,223

(22) PCT Filed: Jan. 14, 2005
(86) PCT No.: PCT/IB05/00088

§ 371 Date: Jul. 17, 2006

(30) Foreign Application Priority Data
Jan. 21, 2004 (EP) 04300033.0

(51) Int. Cl. H04N 7/26

(52) U.S. Cl. 375/240.26; 375/E07.078

(57) ABSTRACT

The invention relates to a method of coding video data available in the form of a first input stream of video frames, and to a corresponding coding device. This method, implemented for instance in three successives stages (101, 102, 103), comprises the steps of (a) encoding said first input stream to produce a first coded base layer stream (BL1) suitable for a transmission at a first base layer bitrate; (b) based on said first input stream and a decoded version of said encoded first base layer stream, generating a first set of residual frames in the form of a first enhancement layer stream and encoding said stream to produce a first coded enhancement layer stream (EL1); and (c) repeating at least once a similar process in order to produce further coded base layer streams (BL2, BL3, . . . ) and further coded enhancement layer streams (EL2, EL3, . . . ). The first input stream is thus, for obtaining a required spatial resolution, compressed by encoding the base layers up to said spatial resolution with a lower bitrate and allocating a higher bitrate to the last base layer and/or to the enhancement which corresponds to said required spatial resolution. A corresponding transmission method is also proposed.

### FIELD OF THE INVENTION

The invention relates to the field of moving picture coding, and more particularly to an algorithm of spatial and SNR fine granular scalable video compression. More precisely, it relates to a method of coding video data available in the form of a first input stream of video frames. The invention also relates to a corresponding coding device and to a transmission system comprising such a coding device.

### BACKGROUND OF THE INVENTION

In many applications, compressed video sequences have to be exploited at different resolutions and qualities. Encoding of video sequences with different levels of resolution or quality may be accomplished by use of scalable coding techniques. One of the possible implementations of the scalability is a layered coding, where an encoded bitstream is separable into two or more bitstreams, or layers, that can be, more or less combined in order to form a single video, stream with a specific quality and/or video resolution, according to a given request.

In case of quality scalability, also called signal-to-noise (SNR) scalability, a base layer (BL) may provide a lower quality video signal, while one or several enhancement layers (ELs) provide additional information that can improve the base layer image. In case of spatial scalability, the base layer video may have a lower resolution than the input video sequence, while the enhancement layers comprise information which can restore the input sequence resolution. An efficient algorithm for providing SNR scalability is the Fine-Granular Scalability (FGS) scheme, which supports a wide range of transmission bandwidths, as described in the document WO 01/03441 (PHA3725), related to a system and method for improved fine granular scalable video using base layer coding information. This scheme bas been adopted as a part of MPEG-4 standard, but, unfortunately, it does not aim to alter the spatial resolution of an image.

It has then been proposed more recently to combine spatial and FGS scalabilities in one scheme, as described for example in the documents WO 02/33952 and WO 03/47260. According to the method described in WO 02/33952, video data images are downscaled and encoded to produce base layer frames. Quality enhanced residual images are generated from the downscaled video data and encoded/decoded BL frames. These residual frames are encoded using FGS technique to produce a quality enhancement layer EL1. The decoded BL signal is added to partially decoded EL1, and the received signal is up-scaled. The difference between received up-scaled signal and input signal is encoded using FGS technique to form a spatial enhancement layer EL2. This method has however several disadvantages:

(a) a stream with only two spatial layers (BL and EL2) is generated, thus spatial scalability range is limited;

(b) the temporal redundancy in the spatial enhancement layer EL2 is not exploited at all, with the main consequence that the method does not work well on sequences with a lot of temporal redundancy;

(c) for generation of EL2, some part of EL1 (with the bitrate REL1) is used, which leads to either a drift and appearance of non-compensated errors, if the real transmission bitrate is lower than REL1, or to a non efficient compression if the transmission bitrate for EL1 is higher than REL1;

(d) the received EL2 is not standard compatible, even with the standard MPEG-4 FGS scheme;

(e) the bitrate allocation between BL, EL1 and EL2 is not easy: there is no guaranteed bitrate (and quality) for the spatial enhancement layer, which leads to fluctuation of quality within the higher resolution image.

### SUMMARY OF THE INVENTION

It is therefore an object of the invention to overcome at least a part of the above-described disadvantages of the state-of-the-art FGS-spatial scalability scheme.

To this end, the invention relates to a method of coding video data available in the form of a first input stream of video frames, said method comprising the steps of:

(A) encoding said first input stream (FIS) to produce a first coded base layer stream (BL1) suitable for a transmission at a first base layer bitrate;

(B) based on said first input stream (FIS) and a locally decoded version of said first coded base layer stream, generating a first set of residual frames in the form of a first enhancement layer stream and encoding said first enhancement layer stream to produce a first coded enhancement layer stream (EL1);

(C) repeating at least once a process of the same type, i.e. generating a second input stream (SIS) by difference between said first input stream (FIS) and said locally decoded version of the first coded base layer stream, and applying to said second input stream (SIS) two steps of the type (A) and (B) in order to produce:
based on said second input stream (SIS), a second coded base layer stream (BL2), suitable for a transmission at a second base layer bitrate; and
based on said second input stream (SIS) and a locally decoded version of said second coded base layer stream, a second set of residual frames in the form of a second enhancement layer stream which is then encoded to generate a second coded enhancement layer stream (EL2);

(D) any further repetition of said process comprising operations similar to the operations provided in (C) but with progressively increased indices in order to produce third coded base and enhancement layer stream (BL3, EL3), etc; said first input stream being thus, for obtaining a predetermined required spatial resolution, compressed by:
a) encoding the base layers (BL1, BL2, . . . ) up to said required spatial resolution with a lower bitrate; and
b) allocating a higher bitrate to the last base layer and/or to the enhancement which corresponds to said required spatial resolution.

Compared with the state-of-the-art techniques, the proposed method, thanks to which three and more spatial resolution layers can be generated, allows a gradual change of quality due to the switching between decoding of a lower resolution enhancement layer or a higher resolution base layer, and, because the non-scalable base layer streams have low bit-rates, it is able to provide a fine granularity of SNR scalability. Moreover, the spatial resolution encoders are within the feedback loops, thus no drift appears at higher resolution and each base layer compensates compression and spatial scaling errors of previous layers.

Preferably, before each repeating step according to (C) or (D), a DC-offset value is added to the input stream corresponding to said repeating step, in order to concentrate the corresponding samples around the middle of the video range, for example 128 for 8 bit video samples. The standard components of the coding device for the enhancement and base layers can then be used, which results in a cost efficient implementation.

It is also an object of the invention to propose a memory medium for storing the codes allowing the implementation of such a method.

To this end, the invention relates to a memory medium including codes for encoding video data available in the form of a first input stream of video frames, said codes being the following ones

(A) a code for encoding said first input stream (FIS) to produce a first coded base layer stream (BL1) suitable for a transmission at a first base layer bitrate;

(B) based on said first input stream (FIS) and a locally decoded version of said first coded base layer stream, a code for generating a first set of residual frames in the form of a first enhancement layer stream and encoding said first enhancement layer stream to produce a first coded enhancement layer stream (EL1);

(C) a code for repeating at least once a process of the same type, i.e. for generating a second input stream (SIS) by difference between said first input stream (FIS) and said locally decoded version of the first coded base layer stream, and for applying to said second input stream (SIS) two steps of the type (A) and (B) in order to produce:
based on said second input stream (SIS), a second coded base layer stream (BL2), suitable for a transmission at a second base layer bitrate; and
based on said second input stream (SIS) and a locally decoded version of said second coded base layer stream, a second set of residual frames in the form of a second enhancement layer stream which is then encoded to generate a second coded enhancement layer stream (EL2);

(D) a code for a further repetition of said process with operations similar to the operations provided in (C) but referenced with progressively increased indices in order to produce third coded base and enhancement layer streams (BL3, EL3, etc).

It is still an object of the invention to propose a coding device allowing to carry out the coding method according to the invention.

To this end, the invention relates to a device for coding video data available in the form of a first input stream of video frames, said coding device comprising the following means:

(A) means for encoding said first input stream (IS) to produce a first coded base layer stream (BL1) suitable for a transmission at a first base layer bitrate;

(B) based on said first input stream (FIS) and a locally decoded version of said encoded first base layer stream, means for generating a first set of residual frames in the form of a first enhancement layer stream and encoding said first enhancement layer stream to produce a first coded enhancement layer stream (EL1);

(C) means for repeating at least once a process of the same type, i.e. for generating a second input stream (SIS) by difference between said first input stream (FIS) and said locally decoded version of the first coded base layer stream, and for applying to said second input stream (SIS) two steps of the type (A) and (B) in order to produce a second coded base layer stream (BL2), suitable for a transmission at a second base layer bitrate, and a second coded enhancement layer stream (EL2);

any further repetition of the process of the step (C) comprising operations similar to the operations provided in (C) but with progressively increased indices in order to produce third coded base and enhancement layer streams (BL3, EL3, etc);

said first input stream being thus, for obtaining a predetermined required spatial resolution, compressed by encoding the base layers (BL1, BL2, . . . ) up to said required spatial resolution with a lower bitrate and allocating a higher bitrate to the last base layer and/or to the enhancement which corresponds to said required spatial resolution.

Such a coding device can be used for instance in a transmission system comprising said device and, within it or in association with it, a controller of the transmission of said coded base layers (BL1, BL2, . . . ) and enhancement layers (EL1, EL2, . . . ) to a plurality of decoders or users belonging to a multimedia network, said controller implementing a transmission of all or some—depending on the bandwidth available—of the coded base layers and, according to the requirements of a specific decoder or user or to associated decoding capabilities, a coded enhancement layer at the corresponding specific resolution only to said decoder or user.

### BRIEF DESCRIPTION OF THE DRAWINGS

The present invention will now be described, by way of example, with reference to the accompanying drawing in which:

FIG. 1 illustrates an example of an encoder according to the invention.

### DETAILED DESCRIPTION OF THE INVENTION

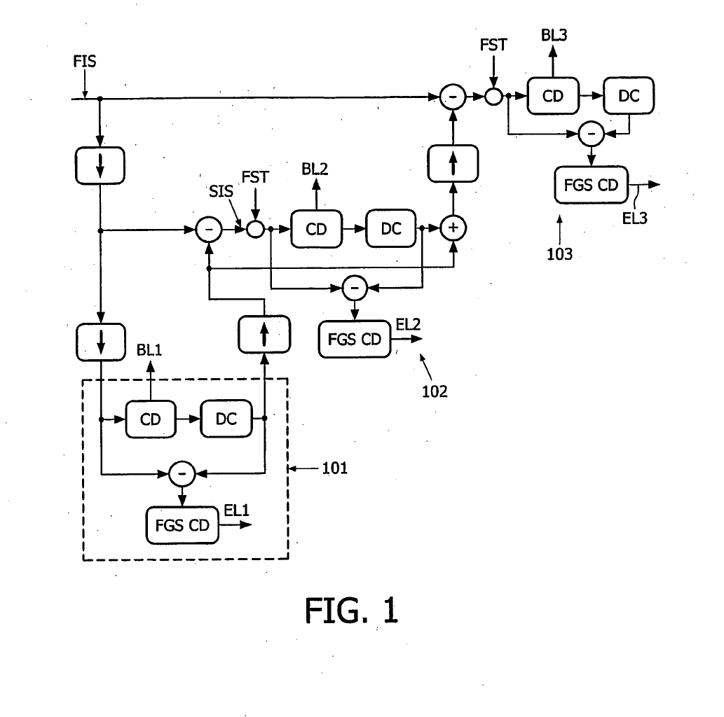

The scheme of the proposed main embodiment is depicted in FIG. 1. The illustrated coder comprises three successive stages (a first stage referenced 101, and two similar stages 102 and 103) generating three levels of spatial scalability and FGS quality enhancement layers for each spatial resolution. The non-scalable streams BL1, BL2, BL3 provide the base layers information, that comprise encoded data required for decoding of video with the minimal quality at three spatial resolutions. Improvement of quality may be achieved by adding the decoded enhancement layers EL1, EL3, EL3 to the corresponding base layers BL1, BL2, BL3. The enhancement layers are encoded by the FGS coders and provide the SNR scalability. Each higher resolution spatial layer compensates errors caused by low bitrate encoding of base layer of the previous spatial level. Only the encoded non-scalable base layers are used for the prediction of higher resolution signals, thus no drift error at the decoding side will appear if the FGS enhancement layers are not received or received and decoded only partly.

The main idea of the invention is based on the assumption that a video signal may be efficiently compressed at the required spatial resolution by encoding the base layers up to said resolution with a very low bit-rate and allocating-higher bit-rate to the last base layer and/or to the one FGS enhancement layer which corresponds to the required spatial resolution. From a video quality point of view, it is more optimal to allocate more bits to the enhancement layer of the required resolution, then to the enhancement layers of previous resolutions. In other words, the enhancement layers at lower resolution have not to be decoded in order to reconstruct the video sequence at higher resolution. In this way it is possible to achieve a high granularity of scalability (because the non-scalable base layers streams have low bitrates), and, at the same time, to provide a high video quality (because all the base layers are in feedback loops and no drift error will appear).

In order to explain how the proposed scheme is working and the bitrate budget is distributed between the layers, the following example is considered. For instance, the input video has the standard definition (SD) spatial resolution, layers BL1 and EL1 (stage 101) have QSIF resolution, layers BL2 and EL2 (stage 102) have SIF resolution, and layers BL3, EL3 (stage 103) have SD resolution, and one wants to reconstruct the SD resolution at the decoding side. The bitrate of the base layer BLn is RBLn, and the bitrate of the enhancement layer Eln is RELn. The channel bandwidth R is growing slowly:

(1) R is equal to RBL1: the base layer stream BL1 is then transmitted and, at the decoding side, BL1 is decoded and twice upscaled;

(2) R is comprised between RBL1 and (RBL1+RBL2): the stream (BL1+EL1) is transmitted;

(3) R is equal to (RBL1+RBL2): the stream (BL1+BL2) is transmitted (and EL1 is not transmitted);

(4) R is comprised between (RBL1+RBL2) and (RBL1+RBL2+RBL3): the stream (BL1+BL2+EL3) is transmitted;

(5) R is equal to (RBL1+RBL2+RBL3): the stream (BL1+BL2+BL3) is transmitted;

(6) R is greater than (RBL1+RBL2+RBL3): the stream (BL1+BL2+BL3+EL3) is transmitted and, in this case, the encoding server does not transmit or the decoder does not decode the enhancement layers (EL1, EL2);

(7) if the bandwidth is sufficiently large, then the quality may be improved further by transmitting all base and enhancement layers (BL1+EL1+BL2+EL2+BL3+EL3), and the decoding of all enhancement layers is then possible (but not required by the proposed scheme).

It appears therefore that there is a switch from the transmission of the enhancement layer EL1 of the previous resolution to the transmission of the base layer BL(i+1) of the next resolution as soon as the bitrate of the previous enhancement layer EL1 becomes equal to or higher than the bitrate of the following base layer BL(i+1). In other words, the switching takes place if REL1=RBL2, REL2=RBL3. Of course, if a decoding side requires a video with resolution lower than the original (maximum), then there is no switch to the next base layer stream and the transmission of the current enhancement layer continues. In this way it is possible to keep the lowest minimal required bitrate for each spatial resolution and to achieve the best rate-distortion tradeoff. The scheme also allows various decoders with different spatial resolution requirements to reconstruct the video at the desired resolution by decoding all previous and current base layers and only one FGS enhancement layer at the required resolution.

The operations of applying an offset, called FST in FIG. 1, before coders CD of BL2 and BL3 are explained in the document WO 03/036981 (PHNL021042) and allow the encoding of the residual data as normal video signals. The combination of the circuits CD, DC, and FGS CD, marked out in FIG. 1 by dashed lines in the case of the stage 101, may be implemented as one MPEG-4 FGS encoder, with the structure described in the first cited document. This structure of encoder generates the non-scalable base layer stream and one FGS enhancement layer stream. The exploitation of this MPEG-4 FGS encoder in the proposed spatial scalable scheme allows generation of layers, which are all standard compatible. The three-layer scheme proposed here may be also implemented as a two-layer scheme if the loop with the lowest spatial resolution (BL1, EL1) is omitted. The described main embodiment of the invention presumes switching between different base and enhancement streams during transmission or decoding according to the preferences and requirements received from the user. In another embodiment of the invention it is possible to combine those FGS enhancement and base layers into one bit-stream. The priority of embedding of the spatial (BL) and SNR (EL) scalable layers into one stream depends on the requirements of an application. For example, if the spatial scalability is most important, then the priority is: BL1, BL2, BL3, EL1, EL2, EL3. If the quality at each resolution is most important, then the priority is: BL1, EL1, BL2, EL2, BL3, EL3.

The idea proposed here is based on the assumption that a high video quality is achievable if bitrates of previous spatial layers are minimal (no EL for lower spatial resolutions) and the bitrate for the required spatial resolution is high (BL+EL). This assumption is opposite to the state-of-the-art method described in the document WO02/33952, where both the base and the enhancement layers of previous spatial resolution are used for prediction of the next spatial resolution. In order to verify this assumption, experiments have been carried out: they have shown that the best quality is achieved if most of a bit budget is allocated to the last spatial layer, which means that it is more optimal to allocate bit budget to. FGS enhancement layer of the required resolution than to the layers of previous lower resolutions. A visual-evaluation confirms these objective results.

The method and device which have been described have the advantages already indicated above, and also the following ones:

(a) standard coders/decoders may be used, which generates the standard compatible streams;

(b) the temporal redundancy in each spatial layer is exploited by means of hybrid motion prediction coding of base layers.

(c) the proposed bit-rate allocation provides the highest efficiency of compression of signals at targeted resolutions due to skipping the decoding of enhancement layers of previous spatial layers.

These method and device may be used for instance in a transmission system—or in association with such a system—that transmits all the base layers encoded according to the proposed coding method within a multimedia network (or only some of these base layers, depending on the bandwidth available). According to the requirements defined by a particular decoder or user (display resolution) or its decoding capabilities (maximum bitrate, processing power), the coding device, in a server, decides to transmit a corresponding FGS enhancement layer at a corresponding resolution only to that decoder or user.

There are numerous ways of implementing functions by means of items of hardware or software, or both. In this respect, the drawings are very diagrammatic, and represent only possible embodiments of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawing, illustrates rather than limits the invention. There are numerous alternatives, which fall within the scope of the appended claims. The words “comprising” or “comprise” do not exclude the presence of other elements or steps than those listed in a claim. The word “a” or “an” preceding an element or step does not exclude the presence of a plurality of such elements or steps.

1. A method of coding video data available in the form of a first input stream of video frames, said method comprising the steps of:
(A) encoding said first input stream (FIS) to produce a-first coded base layer stream (BL1) suitable for a transmission at a first base layer bitrate;
(B) based on said first input stream (FIS) and a locally decoded Version of said first coded base layer stream, generating a first set of residual frames in the form of a first enhancement layer stream and encoding said first enhancement layer stream to produce a first coded enhancement layer stream (EL1);
(C) repeating at least once a process of the same type, i.e. generating a second input stream (SIS) by difference between said first input stream (FIS) and said locally decoded version of the first coded base layer stream, and applying to said second input stream (SIS) two steps of the type (A) and (B) in order to produce:
based on said second input stream (SIS), a second coded base layer stream (BL2), suitable for a transmission at a second base layer bitrate; and
based on said second input stream (SIS) and a locally decoded version of said second coded base layer stream, a second set of residual frames in the form of a second enhancement layer stream which is then encoded to generate a second coded enhancement layer stream (EL2);
(D) any further repetition of said process comprising operations similar to the operations provided in (C) but with progressively increased indices in order to produce third coded base and enhancement layer streams (BL3, EL3, etc);
said first input stream being thus, for obtaining a predetermined required spatial resolution, compressed by:
c) encoding the base layers (BL1, BL2, . . . ) up to said required spatial resolution with a lower bitrate; and
d) allocating a higher bitrate to the last base layer and/or to the enhancement which corresponds to said required spatial resolution.

2. A coding method according to claim 1, in which, before each repeating step according to (C) or (D), a DC-offset value is added to the input stream corresponding to said repeating step.

3. A memory medium including code for encoding video data available in the form of a first input stream of video frames, said code comprising:
(A) a code for encoding said first input stream (FIS) to produce a first coded base layer stream (BL1) suitable for a transmission at a first base layer bitrate;
(B) based on said first input stream (FIS) and a locally decoded version of said first coded base layer stream, a code for generating a first set of residual frames in the form of a first enhancement layer stream and encoding said first enhancement layer stream to produce a first coded enhancement layer stream (EL1);
(C) a code for repeating at least once a process of the same type, i.e. for generating a second input stream (SIS) by difference between said first input stream (FIS) and said locally decoded version of the first coded base layer stream, and for applying to said second input stream (SIS) two steps of the type (A) and (B) in order to produce:
based on said second input stream (SIS), a second coded base layer stream (BL2), suitable for a transmission at a second base layer bitrate; and
based on said second input stream (SIS) and a locally decoded version of said second coded base layer stream, a second set of residual frames in the form of a second enhancement layer stream which is then encoded to generate a second coded enhancement layer stream (EL2);
(D) a code for any further repetition of said process with operations similar to the operations provided in (C) but referenced with progressively increased indices in order to produce third coded base and enhancement layer streams (BL3, EL3, etc).

4. A device for coding video data available in the form of a first input stream of video frames, said coding device comprising the following means:
(A) means for encoding said first input stream (FIS) to produce a first coded base layer stream (BL1) suitable for a transmission at a first base layer bitrate;
(B) based on said first input stream (FIS) and a locally decoded version of said encoded first base layer stream, means for generating a first set of residual frames in the form of a first enhancement layer stream and to encode said first enhancement layer stream to produce a first coded enhancement layer stream (EL1);
(C) means for repeating at least once a process of the same type, i.e. for generating a second input stream (SIS) by difference between said first input stream (FIS) and said locally decoded version of the first coded base layer stream, and for applying to said second input stream (SIS) two steps of the type (A) and (B) in order to produce a second coded base layer stream (BL2), suitable for a transmission at a second base layer bitrate, and a second coded enhancement layer stream (EL2);
any further repetition of the process of the step (C) comprising operations similar to the operations provided in (C) but with progressively increased indices in order to produce third coded base and enhancement layer streams (BL3, EL3, etc);
said first input stream being thus, for obtaining a predetermined required spatial resolution, compressed by encoding the base layers (BL1, BL2, . . . ) up to said required spatial resolution with a lower bitrate and allocating a higher bitrate to the last base layer and/or to the enhancement which corresponds to said required spatial resolution.

5. A transmission system comprising a video coding device according to claim 4 and, in said device or in association with it, a controller of the transmission of said coded base layers (BL1, BL2, . . . ) and enhancement layers (EL1, EL2, . . . ) to a plurality of decoders or users belonging to a multimedia network, said controller implementing a transmission of all or some—depending on the bandwidth available—of the coded base layers and, according to the requirements of a specific decoder or user or to associated decoding capabilities, a coded enhancement layer at the corresponding specific resolution only to said decoder or user.
